(19) United States
(12) Patent Application Publication
(10) Pub. No.: US 2021/0118593 A1
(43) Pub. Date: Apr. 22, 2021

(54) DIRECT CURRENT POWER CABLE

(71) Applicant: LS CABLE & SYSTEM LTD., Anyang-si, Gyeonggi-do (KR)

(72) Inventors: Young Eun CHO, Yeongdeungpo-gu, Seoul (KR); Jin Ho NAM, Gangnam-gu, Seoul (KR); Gi Joon NAM, Seocho-gu, Seoul (KR)

(21) Appl. No.: 16/604,422

(22) PCT Filed: Dec. 7, 2017
(86) PCT No.: PCT/KR2017/014343

§ 371 Date: Oct. 10, 2019

(30) Foreign Application Priority Data
Apr. 12, 2017 (KR) 10-2017-0047555

(51) Int. Cl. H01B 9/02; H01B 3/44; H01B 1/20; H01B 7/02

(52) U.S. Cl. CPC H01B 9/027; H01B 7/02; H01B 1/20; H01B 3/448

(57) ABSTRACT

Provided is a direct-current (DC) power cable. Specifically, the present invention relates to a DC power cable capable of preventing both a decrease in DC dielectric strength and a decrease in impulse breakdown strength due to space charge accumulation, and reducing manufacturing costs without lowering the extrudability of an insulating layer and the like.

### TECHNICAL FIELD

The present invention relates to a direct-current (DC) power cable. Specifically, the present invention relates to a DC power cable capable of preventing both a decrease in DC dielectric strength and a decrease in impulse breakdown strength due to space charge accumulation, and reducing manufacturing costs without lowering the extrudability of an insulating layer and the like.

### BACKGCIRCULAR ART

In general, in a large power system in which large-capacity and long-distance power transmission is required, high voltage transmission is necessary to increase a transmission voltage in terms of reduction of power loss, a construction site problem, and an increase in power transmission capacity.

Power transmission methods may be largely classified into an alternating-current (AC) power transmission method and a direct-current (DC) power transmission method. The DC power transmission method refers to transmission of power by direct current. Specifically, in the DC power transmission method, first, a power transmission side converts AC power into an appropriate voltage, converts the voltage into direct current by a converter, and transmits the direct current to a power reception side, and the power reception side converts the direct current into AC power by an inverter.

In particular, the DC transmission method has been widely used, because this method is advantageous in transmitting a large amount of power over a long distance and can be operated in connection with an asynchronous power system, and a loss rate of direct current is low and a stability thereof is high in long-distance transmission, compared to alternating current.

However, if power is transmitted using a high-voltage DC power transmission cable, insulation characteristics of an insulator of the cable are remarkably degraded when the temperature of the insulator increases or when a negative impulse or polarity reversal occurs. It is known that this problem is due to the accumulation of long-life space charges as charges are trapped or not discharged from one end of the insulator.

The above-mentioned space charges may distort an electric field in the insulator of the high-voltage DC power transmission cable and thus dielectric breakdown may occur at a voltage lower than an initially designed breakdown voltage.

Accordingly, there is an urgent need for a DC power cable capable of preventing both a decrease in DC dielectric strength and a decrease in impulse breakdown strength due to space charge accumulation and reducing manufacturing costs without reducing the extrudability of an insulating layer and the like.

### DETAILED DESCRIPTION OF THE INVENTION

### Technical Problem

The present invention is directed to providing a direct-current (DC) power cable capable of preventing both a decrease in DC dielectric strength and a decrease in impulse breakage strength due to space charge accumulation.

The present invention is also directed to providing a DC power cable, in which manufacturing costs can be reduced without lowering the extrudability of the insulating layer and the like.

### Technical Solution

According to an aspect of the present invention, provided is a direct-current (DC) power cable comprising: a conductor; an inner semiconducting layer covering the conductor; an insulating layer covering the inner semiconducting layer; an outer semiconducting layer covering the insulating layer; and an outer cover covering the outer semiconducting layer, wherein the inner semiconducting layer or the outer semiconducting layer is formed of a semiconducting composition comprising a copolymer resin of an olefin and a polar monomer as a base resin and conductive particles dispersed in the resin, an amount of the polar monomer is 18 wt % or less, based on total weight of the copolymer resin, and a field enhancement factor (FEF) of the insulating layer defined by Equation below is in a range of 100 to 150%,

FEF=(maximally increased electric field in sample/electric field applied to sample)*100, [Equation 1]

wherein the sample comprises:

an insulating film having a thickness of 120 μm and formed of an insulating composition of the insulating layer; and

semiconducting films respectively bonded to an upper surface and a lower surface of the insulating film, each having a thickness of 50 μm, and formed of the semiconducting composition,

the electric field applied to the sample comprises a 50 kV/mm DC electric field applied to the insulating film for one hour, and

the maximally increased electric field comprises a maximum value among increase values of the electric field for one hour during which the DC electric field is applied to the insulating film.

According to another of the present invention, provided is the DC power cable, wherein the semiconducting composition further comprises a cross-linking agent, wherein an amount of the cross-linking agent is 0.1 to 5 parts by weight, based on 100 parts by weight of the base resin.

According to other of the present invention, provided is the DC power cable, wherein an amount of the polar monomer is 1 to 12 wt %.

According to other of the present invention, provided is the DC power cable, wherein the polar monomer comprises an acrylate monomer.

According to other of the present invention, provided is the DC power cable, wherein the copolymer resin comprises at least one selected from the group consisting of ethylene vinyl acetate (EVA), ethylene methyl acrylate (EMA), ethylene methyl methacrylate (EMMA), ethylene ethyl acrylate (EEA), ethylene ethyl methacrylate (EEMA), ethylene (iso) propyl acrylate (EPA), ethylene (iso) propyl methacrylate (EPMA), ethylene butyl acrylate (EBA), and ethylene butyl methacrylate (EBMA).

According to other of the present invention, provided is the DC power cable, wherein an amount of the cross-linking agent is 0.1 to 1.5 parts by weight.

According to other of the present invention, provided is the DC power cable, wherein the cross-linking agent comprises a peroxide cross-linking agent.

According to other of the present invention, provided is the DC power cable, wherein the peroxide cross-linking agent comprises at least one selected from the group consisting of dicumyl peroxide, benzoyl peroxide, lauryl peroxide, t-butyl cumyl peroxide, di(t-butyl peroxy isopropyl) benzene, 2,5-dimethyl-2,5-di(t-butyl peroxy) hexane, and di-t-butyl peroxide.

According to other of the present invention, provided is the DC power cable, wherein an amount of the conductive particles is 45 to 70 parts by weight, based on 100 parts by weight of the base resin.

According to other of the present invention, provided is the DC power cable, wherein the insulating layer is formed of an insulating composition containing a polyolefin resin as a base resin.

According to other of the present invention, provided is the DC power cable, wherein the insulating layer is formed of a crosslinked polyethylene (XLPE) resin.

### Advantageous Effects

A DC power cable according to the present invention is advantageous in that a base resin and a crosslinking degree of a semiconducting layer can be accurately controlled to prevent accumulation of space charges in an insulating layer, thereby preventing a decrease in both DC dielectric strength and impulse breakdown strength.

In addition, the present invention is advantageous in that the amount of inorganic particles to be contained in the insulating layer to suppress the accumulation of space charges can be reduced to suppress a reduction of the extrudability of the insulating layer due to the inorganic particles, and an increase in a thickness of the insulating layer can be suppressed to reduce manufacturing costs.

### DESCRIPTION OF THE DRAWINGS

FIG. 1 is a schematic cross-sectional view of a power cable according to an embodiment of the present invention.

FIG. 2 is a schematic cross-sectional view of a power cable according to another embodiment of the present invention.

FIG. 3 illustrates FT-IR evaluation results of examples.

FIG. 4 illustrates PEA evaluation results of examples.

### MODE OF THE INVENTION

Hereinafter, exemplary embodiments of the present invention will be described in detail. The present invention is, however, not limited thereto and may be embodied in many different forms. Rather, the embodiments set forth herein are provided so that this disclosure may be thorough and complete and fully convey the scope of the invention to those skilled in the art. Throughout the specification, the same reference numbers represent the same elements.

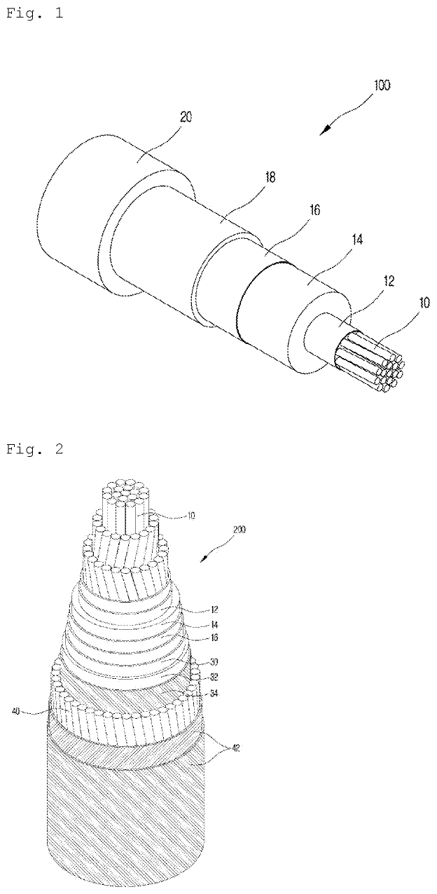

FIG. 1 is a schematic cross-sectional view of a direct-current (DC) power cable according to an embodiment of the present invention. As illustrated in FIG. 1, the DC power cable 100 according to the present invention may include a center conductor 10, an inner semiconducting layer 12 covering the center conductor 10, an insulating layer 14 covering the inner semiconducting layer 12, an outer semiconducting layer 16 covering the insulating layer 14, a shielding layer 18 covering the outer semiconducting layer 16 and formed of a metal sheath or a neutral wire for electrical shielding and a return for short-circuit current, an outer cover 20 covering the shielding layer 18, and the like.

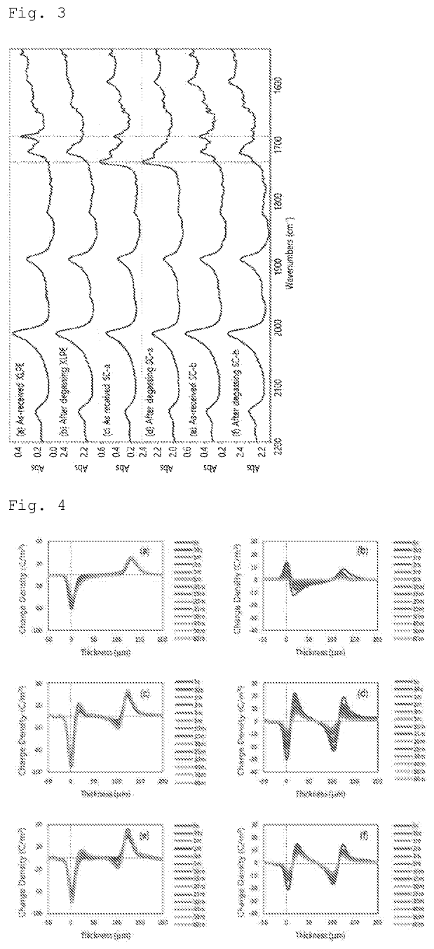

FIG. 2 is a schematic cross-sectional view of a DC power cable according to another embodiment of the present invention. A schematic cross-sectional view of a submarine cable is illustrated herein.

As illustrated in FIG. 2, a conductor 10, an inner semiconducting layer 12, an insulating layer 14, and an outer semiconducting layer 16 of a DC power cable 200 according to the present invention are substantially the same as those of the embodiment of FIG. 1 described above and thus a description thereof are omitted.

A metal sheath formed of lead, so-called a ‘lead sheath’ 30, is provided on an outer side of the outer semiconducting layer 16 to prevent deterioration of the insulation performance of the insulating layer 14 due to intrusion of a foreign substance such as external water.

Furthermore, a bedding layer 34 is provided on an outer side of the lead sheath 30 to prevent the sheath 32 formed of a resin, such as polyethylene, from being in direct contact with water. A wire sheath 40 may be provided on the bedding layer 34. The wire sheath 40 is provided on an outer side of the cable to increase mechanical strength so as to protect the cable from an external environment at the seabed.

A jacket 4 is provided as an outer cover of the cable on an outer side of the wire sheath 40, i.e., an outer side of the cable. The jacket 42 is provided on the outer side of the cable to protect the internal components of the cable 200. In particular, in the case of a submarine cable, the jacket 42 has high weather resistance and high mechanical strength to withstand a submarine environment such as seawater. For example, the jacket 42 may be formed of polypropylene yarn or the like.

The center conductor 10 may be a single wire formed of copper or aluminum, and preferably, copper, or a stranded wire consisting of a plurality of wires. The specifications of the center conductor 10, e.g., a diameter of the center conductor 10, a diameter of the wires of the stranded wire, etc., may vary according to a transmission voltage, use, etc. of the DC power cable including the center conductor 10, and may be appropriately selected by those of ordinary skill in the art. For example, when the DC power cable according to the present invention is used as a submarine cable requiring installation properties, flexibility, etc., the center conductor 10 is preferably a stranded wire having higher flexibility than a single wire.

The inner semiconducting layer 12 is disposed between the center conductor 10 and the insulating layer 14 to eliminate an air layer causing peeling-off between the center conductor 10 and the insulating layer 14 and alleviate local electric field concentration. The outer semiconducting layer 16 allows a uniform electric field to be applied to the insulating layer 14, alleviates local electric field concentration, and protects the insulating layer 14 of the cable from the outside.

In general, the inner semiconducting layer 12 and the outer semiconducting layer 16 are formed by extrusion of a semiconducting composition in which conductive particles, such as carbon black, carbon nanotubes, carbon nanoplates or graphite, are dispersed in a base resin and a cross-linking agent, an antioxidant, a scorch inhibitor, or the like is additionally added.

Here, the base resin is preferably formed of an olefin resin similar to the base resin of the insulating composition of the insulating layer 14 for interlayer adhesion between the semiconducting layers 12 and 16 and the insulating layer 14. More preferably, the base resin is formed of olefin and a polar monomer, e.g., ethylene vinyl acetate (EVA), ethylene methyl acrylate (EMA), ethylene methyl methacrylate (EMMA), ethylene ethyl acrylate (EEA), ethylene ethyl methacrylate (FEMA), ethylene (iso) propyl acrylate (EPA), ethylene (iso) propyl methacrylate (EPMA), ethylene butyl acrylate (EBA), ethylene butyl methacrylate (EBMA) or the like, in consideration of compatibility with the conductive particles.

In addition, the cross-linking agent may be a silane cross-linking agent or an organic peroxide cross-linking agent, such as dicumyl peroxide, benzoyl peroxide, lauryl peroxide, t-butyl cumyl peroxide, di(t-butyl peroxy isopropyl) benzene, 2,5-dimethyl-2,5-di(t-butyl peroxy) hexane, or di-t-butyl peroxide.

The present inventors have completed the present invention by empirically proving that a copolymer resin of olefin and a polar monomer and/or a polar monomer, when used as a base resin contained in a semiconducting composition for forming the inner semiconducting layer 12 and the outer semiconducting layer 16, moved into the insulating layer 14 via an interface between the inner semiconducting layer 12 and the insulating layer 14 and thus accumulation of space charges in the insulating layer 14 was accelerated, and cross-linking byproducts generated during crosslinking of the semiconducting layers 12 and 16 moved into the insulating layer 14 via the interface between the inner semiconducting layer 12 and the insulating layer 14 and thus distortion of an electric field was accelerated due to accumulation of heterocharges in the insulating layer 14, thereby lowering a breakdown voltage of the insulating layer 14.

In particular, in the DC power cable according to the present invention, a field enhancement factor (FEF) of the insulating layer 14 defined by Equation 1 below may be in a range of 100 to 150%.

FEF=(maximally increased electric field/applied electric field)*100 [Equation 1]

Here, the present inventors have completed the present invention by experimentally proving that when the FEF of the insulating layer 14 was greater than 150%, an electric charge was greatly distorted due to excessive accumulation of space charges in the insulating layer 14.

For reference, the FEF of the insulating layer 14 may be measured by applying a 50 kV/mm DC electric field to a sample, which included an insulating film having a thickness of about 120 μm and formed of an insulating composition of the insulating layer 14 and semiconducting films having a thickness of 50 μm, respectively bonded to upper and lower surfaces of the insulating film, and formed of a semiconducting composition of the inner semiconducting layer 12, for one hour and thereafter calculating a ratio of a maximum value to increase values of the applied electric field.

Specifically, in the DC power cable according to the present invention, an amount of the copolymer resin of olefin and the polar monomer may be about 60 to 70 wt %, based on the total weight of the semiconducting composition of the semiconducting layer 12, and an amount of the polar monomer may be accurately controlled to be 1 to 18 wt %, and preferably, 1 to 12 wt %, based on total weight of the copolymer resin.

Here, when the amount of the polar monomer is greater than 18 wt %, the accumulation of space charges in the insulating layer 14 may be greatly accelerated, whereas when the amount of the polar monomer is less than 1 wt %, the compatibility between the base resin and the conductive particles may decrease and the extrudability of the semiconducting layers 12 and 16 may be reduced and thus semiconducting characteristics may not be realized.

In addition, in the DC power cable according to the present invention, in the semiconducting composition of the inner semiconducting layer 12, the amount of the cross-linking agent may be accurately controlled to be 0.1 to 5 parts by weight, and preferably, 0.1 to 1.5 parts by weight, based on 100 parts by weight of the base resin.

Here, when the amount of the cross-linking agent is greater than 5 parts by weight, the amount of cross-linking byproducts inevitably generated during crosslinking of the base resin contained in the semiconducting composition may be excessive and move into the insulating layer 14 via the interface between the semiconducting layers 12 and 16 the insulating layer 14 and thus distortion of an electric field may be accelerated due to the accumulation of heterocharges, thereby reducing a breakdown voltage of the insulating layer 14. In contrast, when the amount of the cross-linking agent is less than 0.1 parts by weight, a degree of cross-linking is insufficient and thus mechanical properties, heat resistance, etc. of the semiconducting layers 12 and 16 may be insufficient.

In the DC power cable according to the present invention, the semiconducting composition of each of the inner and outer semiconducting layers 12 and 16 may contain 45 to 70 parts by weight of conductive particles such as carbon black, based on 100 parts by weight of the base resin. When the amount of the conductive particles is less than 45 parts by weight, sufficient semiconducting properties may not be realized, whereas when the amount of the conductive particles is greater than 70 parts by weight, the extrudability of the inner and outer semiconducting layers 12 and 16 may decrease and thus surface properties or productivity may be lowered.

Thicknesses of the inner and outer semiconducting layers 12 and 16 may vary according to a transmission voltage of the cable. For example, in the case of a 345 kV power cable, the thickness of the inner semiconducting layer 12 may be in a range of 1.0 to 2.5 mm and the thickness of the outer semiconducting layer 16 may be in a range of 1.0 to 2.5 mm.

The insulating layer 14 may be formed of, for example, a polyolefin resin, such as polyethylene or polypropylene, as a base resin, and may be preferably formed by extrusion of an insulating composition containing a polyethylene resin.

The polyethylene resin may include ultra-low-density polyethylene (ULDPE), low-density polyethylene (LDPE), linear low-density polyethylene (LLDPE), medium=density polyethylene (MDPE), high-density polyethylene (HDPE), or a combination thereof. Alternatively, the polyethylene resin may include a homopolymer, a random or block copolymer of α-olefin, such as ethylene, propylene, 1-butene, 1-pentene, 1-hexene, or 1-octene, or a combination thereof.

In addition, the insulating composition of the insulating layer 14 may include a cross-linking agent and thus the insulating layer 14 may be crosslinked as crosslinked polyolefin (XLPO), and preferably, crosslinked polyethylene (XLPE), by a separate crosslinking process during or after extrusion. Alternatively, the insulating composition may further include other additives such as an antioxidant, an extrusion enhancer, and a crosslinking aid.

The cross-linking agent contained in the insulating composition may be the same as that contained in the semiconducting composition, and may be, for example, a silane cross-linking agent or an organic peroxide cross-linking agent, such as dicumyl peroxide, benzoyl peroxide, lauryl peroxide, t-butyl cumyl peroxide, di(t-butyl peroxy isopropyl) benzene, 2,5-dimethyl-2,5-di(t-butyl peroxy) hexane, or di-t-butyl peroxide. Here, in the insulating composition, the cross-linking agent may be contained in an amount of 0.1 to 5 parts by weight, based on 100 parts by weight of the base resin.

The amounts of the polar monomer and the cross-linking agent of the base resin contained in the semiconducting layers and 16 in contact with the insulating layer 14 may be accurately controlled to suppress generation of heterocharges at the interface between the insulating layer 14 and the semiconducting layers 12 and 16 and reduce accumulation of space charges. Thus, inorganic particles such as magnesium oxide for reducing the space charges may not be contained or the amount thereof may be significantly reduced, thereby suppressing the extrudability of the insulating layer 14 and impulse strength from being reduced due to the inorganic particles.

The thickness of the insulating layer 14 may vary according to the transmission voltage of the power cable. For example, in the case of a 345 kV power cable, the thickness of the insulating layer 14 may be in a range of 23.0 to 31.0 mm.

The jacket layer 20 may include polyethylene, polyvinyl chloride, polyurethane, or the like. For example, the jacket layer 20 may be formed of, preferably, a polyethylene resin, and more preferably, a high-density polyethylene (HDPE) resin, in consideration of mechanical strength because the jacket layer 20 is provided on an outermost side of the cable. In addition, the jacket layer 20 may include a small amount of an additive such as carbon black, for example, 2 to 3 wt % of the additive, to implement a color of the DC power cable, and have a thickness of, for example, 0.1 to 8 mm.

### EXAMPLES

1. Preparation Examples of Samples

For a pulsed electro-acoustic (PEA) evaluation, an insulating thin-film and an insulating+semiconducting thin-film were prepared as illustrated in a figure below.

Specifically, the insulating thin-film was prepared by manufacturing a thin film by heat-compressing an insulating composition containing a polyethylene resin, a peroxide cross-linking agent, and other additives at 120° C. for five minutes, crosslinking the thin film at 180° C. for eight minutes, cooling the thin film to 120° C. and thereafter cooling the thin film again at room temperature. The thickness of the prepared insulating thin film was about 120 μm.

The insulating+semiconducting thin-film was prepared by manufacturing an insulating thin-film by heat-compressing an insulating composition containing a polyethylene resin, a peroxide cross-linking agent, and other additives at 120° C. for five minutes, manufacturing a semiconducting thin-film by heat-compressing a semiconducting composition containing a butyl acrylate (BA)-containing resin, a peroxide cross-linking agent and other additives at 120° C. for five minutes, bonding the semiconducting thin-film to front and rear surfaces of the insulating thin-film, melting a resultant structure at 120° C. for five minutes to thermally bond these films to each other, crosslinking the resultant structure at 180° C. for eight minutes, cooling the resultant structure to 120° C., and then cooling the resultant structure at room temperature. The thicknesses of the prepared insulating thin-film and semiconducting thin-film were about 120 μm and about 50 μm, respectively.

Here, an insulating+semiconducting thin-film including a semiconducting (SC-a) thin-film formed of a semiconducting composition in which an amount of butyl acrylate (BA) was 17 wt % based on the total weight of a resin, and an insulating+semiconducting thin-film including a semiconducting (SC-b) thin-film formed of a semiconducting composition in which an amount of a butyl acrylate (BA) was 3 wt % based on the total weight of the resin were prepared.

For FT-IR evaluation, thicker films were prepared, in which the thickness of the insulating thin-film was 20 mm and the thickness of the semiconducting thin-film was 1 mm. In each of the insulating+semiconducting thin-films, a semiconducting film was bonded to only one side of an insulating film and a resultant structure was cut into a cross section by a 1-mm microtome. In addition, films were additionally prepared by removing cross-linking byproducts from each of the insulating thin-film, the insulating+semiconducting (SC-a) thin-film, and the insulating+semiconducting (SC-b) thin-film by performing degassing in a vacuum state at 70° C. for 5 days.

1. Evaluation of Physical Properties

1) FT-IR Evaluation

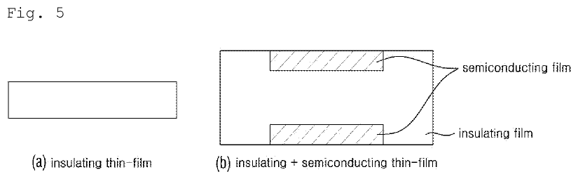

Spectral data was collected from a range of 4000 to 650 cm⁻¹ with a resolution of 4 cm⁻¹ by scanning 64 times to determine whether there was a transfer of acrylate and cross-linking byproducts between the insulating film and the semiconducting film. An FT-IR evaluation was performed by a Varian 7000e spectrometer equipped with a microscope and an MCT detector. Evaluation results are as shown in FIG. 3.

As illustrated in FIG. 3, a peak of 1694.3 cm⁻¹ indicating acetophenone which is one of the cross-linking byproducts was observed from an insulating thin-film (a), an insulating+semiconducting (SC-a) thin-film (c), and an insulating+semiconducting (SC-b) thin-film (e) from which cross-linking byproducts were not removed by degassing, whereas the peak of 1694.3 cm⁻¹ indicating acetophenone was not observed from an insulating thin-film (b), an insulating+semiconducting (SC-a) thin-film (d), and an insulating+semiconducting (SC-b) thin-film (f) from which cross-linking byproducts were removed by degassing and thus the cross-linking byproducts were transferred to the semiconducting film to the insulating film.

In addition, a peak of 1735.6 cm⁻¹ indicating an acrylate resin was not observed from the insulating thin-films (a) and (b) to which a semiconducting film was not bonded but was observed from the insulating+semiconducting thin-films (c), (d), (e) and (f) to which a semiconducting film was bonded. In particular, an intensity of the peak of 1735.6 cm⁻¹ indicating an acrylate resin was high in the insulating+semiconducting (SC-b) thin film (d) including a semiconducting film with relatively high acrylate content and thus a degree of transfer of the acrylate resin from the semiconducting film to the insulating film was high, compared to the insulating+semiconducting (SC-b) thin film (e) including a semiconducting film with relatively low acrylate content.

2) Evaluation of Behaviors of Heterocharges and Space Charges and FET

A pulsed electro-acoustic (PEA) evaluation was performed on the prepared insulating thin-films, insulating+semiconducting (SC-a) thin films, and insulating+semiconducting (SC-b) thin-films. Specifically, a 50 kV/mm DC electric field was applied to these films at room temperature for one hour, the applying of the electric field was stopped, and short-circuiting was performed for one hour. Current density when the DC electric field was applied and current density when short-circuiting was performed were measured using the LabView program. Evaluation results are as shown in FIG. 4.

In a graph of FIG. 4 showing charge densities measured by time, integral values representing an electric field were calculated and a maximum value among the integral values was selected to calculate an FEF using Equation 1 above. A result of measuring an increase value of an electric field by time and a result of calculating an FEF with respect to each of the samples (a), (c), and (e) are shown in Table 1 below. The numerical values shown in Table 1 below are expressed in kV/mm indicating electric-field values unless otherwise indicated.

TABLE 1

| | | sample (a) | sample (c) | sample (e) |
|---|---|---|---|---|
| 5 | seconds | 102 | 112 | 104 |
| 30 | seconds | 102 | 118 | 106 |
| 1 | minutes | 102 | 116 | 106 |
| 2 | minutes | 102 | 118 | 110 |
| 3 | minutes | 104 | 122 | 114 |
| 5 | minutes | 106 | 122 | 118 |
| 10 | minutes | 108 | 126 | 96 |
| 15 | minutes | 106 | 128 | 120 |
| 20 | minutes | 106 | 128 | 116 |
| 25 | minutes | 106 | 128 | 122 |
| 30 | minutes | 108 | 126 | 126 |
| 40 | minutes | 106 | 132 | 126 |
| 50 | minutes | 110 | 132 | 124 |
| 60 | minutes | 112 | 134 | 124 |

| | | | |
|---|---|---|---|
| FET (%) | 112 | 134 | 126 |

As illustrated in FIG. 4, the insulating thin-film was not bonded to the semiconducting thin-film and thus cross-linking byproducts generated during crosslinking of the semiconducting thin-film did not move toward the insulating thin-film, thereby preventing formation of heterocharges. In addition, butyl acrylate (BA) of the semiconducting thin-film did not move toward the insulating thin-film. Thus, a rate of accumulation of space charges was low in the sample (a) to which a DC electric field was applied and the sample (b) in which application of an electric field was stopped and thus FEFs thereof were low.

In contrast, according to the number of peaks illustrated in FIG. 4, in the insulating+semiconducting thin-film, cross-linking byproducts generated during crosslinking of the semiconducting thin-film moved toward the insulating thin-film and thus heterocharges were formed near an interface between the insulating thin-film and the semiconducting thin-film, and the butyl acrylate (BA) of the semiconducting thin-film moved toward the insulating thin-film. Therefore, in the sample (c) (SC-b) and the sample (e) (SC-b)to which a DC electric field was applied and the sample (d) (SC-a) and the sample (f) (SC-b) in which the application of the DC electric field was stopped, a relatively large amount of space charges were accumulated near the interface between the insulating thin-film and the semiconducting thin-film and thus FEFs of these samples were relatively high. In particular, more space charges were accumulated in the insulating+semiconducting (SC-a) thin film with high butyl acrylate (BA) content than in the insulating+semiconducting (SC-b) thin-film with relatively low butyl acrylate (BA) content and thus an FET thereof was relatively high.

While the present invention has been described above with respect to exemplary embodiments thereof, it would be understood by those of ordinary skilled in the art that various changes and modifications may be made without departing from the technical conception and scope of the present invention defined in the following claims. Thus, it is clear that all modifications are included in the technical scope of the present invention as long as they include the components as claimed in the claims of the present invention.

1. A direct-current (DC) power cable comprising:
a conductor;
an inner semiconducting layer covering the conductor;
an insulating layer covering the inner semiconducting layer;
an outer semiconducting layer covering the insulating layer; and
an outer cover covering the outer semiconducting layer,
wherein the inner semiconducting layer or the outer semiconducting layer is formed of a semiconducting composition comprising a copolymer resin of an olefin and a polar monomer as a base resin and conductive particles dispersed in the resin,
an amount of the polar monomer is 18 wt % or less, based on total weight of the copolymer resin, and
a field enhancement factor (FEF) of the insulating layer defined by Equation below is in a range of 100 to 150%,
FEF=(maximally increased electric field in sample/electric field applied to sample)*100, [Equation 1]
wherein the sample comprises:
an insulating film having a thickness of 120 μum and formed of an insulating composition of the insulating layer; and
semiconducting films respectively bonded to an upper surface and a lower surface of the insulating film, each having a thickness of 50 μm, and formed of the semiconducting composition,
the electric field applied to the sample comprises a 50 kV/mm DC electric field applied to the insulating film for one hour, and
the maximally increased electric field comprises a maximum value among increase values of the electric field for one hour during which the DC electric field is applied to the insulating film.

2. The DC power cable of claim 1, wherein the semiconducting composition further comprises a cross-linking agent,
wherein an amount of the cross-linking agent is 0.1 to 5 parts by weight, based on 100 parts by weight of the base resin.

3. The DC power cable of claim 1, wherein an amount of the polar monomer is 1 to 12 wt %.

4. The DC power cable of claim 1, wherein the polar monomer comprises an acrylate monomer.

5. The DC power cable of claim 4, wherein the copolymer resin comprises at least one selected from the group consisting of ethylene vinyl acetate (EVA), ethylene methyl acrylate (EMA), ethylene methyl methacrylate (EMMA), ethylene ethyl acrylate (EEA), ethylene ethyl methacrylate (EEMA), ethylene (iso) propyl acrylate (EPA), ethylene (iso) propyl methacrylate (EPMA), ethylene butyl acrylate (EBA), and ethylene butyl methacrylate (EBMA).

6. The DC power cable of claim 2, wherein an amount of the cross-linking agent is 0.1 to 1.5 parts by weight.

7. The DC power cable of claim 2, wherein the cross-linking agent comprises a peroxide cross-linking agent.

8. The DC power cable of claim 7, wherein the peroxide cross-linking agent comprises at least one selected from the group consisting of dicumyl peroxide, benzoyl peroxide, lauryl peroxide, t-butyl cumyl peroxide, di(t-butyl peroxy isopropyl) benzene, 2,5-dimethyl-2,5-di(t-butyl peroxy) hexane, and di-t-butyl peroxide.

9. The DC power cable of claim 1, wherein an amount of the conductive particles is 45 to 70 parts by weight, based on 100 parts by weight of the base resin.

10. The DC power cable of claim 1, wherein the insulating layer is formed of an insulating composition containing a polyolefin resin as a base resin.

11. The DC power cable of claim 10, wherein the insulating layer is formed of a crosslinked polyethylene (XLPE) resin.
